(19) United States
(12) Patent Application Publication
(10) Pub. No.: US 2019/0190426 A1
(43) Pub. Date: Jun. 20, 2019

(54) METHOD AND DEVICE FOR REDUCING MECHANICAL LOADS IN A POWERTRAIN

(71) Applicant: Robert Bosch GmbH, Stuttgart (DE)

(72) Inventors: Wolfgang Michael Bischof, Ludwigsburg (DE); Elena Tonkonog, Ludwigsburg (DE); Florian Draeger, Kirchheim Am Neckar (DE); Stefan Teusch, Reutlingen (DE); David Rychtarik, Schwieberdingen (DE); Elias Calva, Stuttgart (DE); Gunther Goetting, Stuttgart (DE); Stefan Mittank, Stuttgart (DE)

(73) Assignee: Robert Bosch GmbH, Stuttgart (DE)

(21) Appl. No.: 16/311,310

(22) PCT Filed: Jun. 14, 2017
(86) PCT No.: PCT/EP2017/064487

§ 371 Date: Dec. 19, 2018

(30) Foreign Application Priority Data
Jun. 24, 2016 (DE) 10 2016 211 394.1

(51) Int. Cl. H02P 23/04; B60L 15/02; H02P 6/10

(52) U.S. Cl. CPC H02P 23/04; H02P 29/50; H02P 6/10; B60L 15/02

(57) ABSTRACT

The invention relates to a method (300) and a device (170) for reducing mechanical loads in a powertrain (100). An electric machine (130) is provided as the drive assembly of the powertrain (100), and an inverter (110) is provided in order to output a multiphase output voltage for supplying the electric machine (130). The method (300) has the following steps: determining (320) the multiphase output voltage (UA) for operating the electric machine (130); adding (340) a specifiable voltage (VU) and the specified output voltage (UA); and outputting (350) the sum (SU) of the multiphase output voltage (UA) and the specifiable voltage (VU) in order to supply the electric machine (130).

### BACKGROUND OF THE INVENTION

The invention relates to a method and a device for reducing mechanical loads in a powertrain. The invention further relates to a powertrain having a corresponding device, and to a vehicle having a powertrain, together with a computer program and a machine-readable storage medium.

As a result of manufacturing tolerances in the production and assembly of powertrains, a rotor shaft, for example, is not perfectly centered, or is slightly eccentrically arranged within the stator of an electric machine, or the rotor is slightly excentrically displaced or skewed in the stator. Within a powertrain, there are extensive areas which cannot be executed ideally, but only within certain tolerances, including e.g. imperfect fitting accuracy in flanges, for example between an electric machine and a gearbox, but also the mutual play between gear wheels in a gearbox, or in the bearings of individual gear wheels and shafts. Inaccuracies of this type result in the uneven loading of adjoining components, such as e.g. bearings or other mutual connections between components. The reduction of these mechanical inaccuracies, by means of a reduction in tolerances for manufacture and assembly, is highly complex. There is consequently the requirement for alternative methods for the reduction of uneven mechanical loads in a powertrain.

### SUMMARY OF THE INVENTION

A method is provided for reducing mechanical loads in a powertrain. An electric machine is provided as the drive assembly of the powertrain, and an inverter is provided for the output of a multi-phase output voltage for supplying the electric machine. The method comprises the following steps: determination of the multi-phase output voltage for operating the electric machine; addition of a specifiable voltage and the specified output voltage; output of the sum of the multi-phase output voltage and the specifiable voltage for the supply of the electric machine.

A method is provided for reducing mechanical loads in an electric powertrain. The electric powertrain, as a drive assembly, comprises an electric machine which drives at least one drive shaft, and specifically at least one drive wheel, specifically via a gearbox. An inverter is further provided, which delivers a multi-phase output voltage for the supply of the electric machine. The method comprises the determination of the multi-phase output voltage for the operation of the electric machine. This multi-phase output voltage is specifically defined in relation to a preferred torque. Additionally, in accordance with individual mechanical loads on the powertrain, a further specifiable electric voltage is specified, which is added to, or superimposed upon, the multi-phase output voltage thus determined. Consideration of individual mechanical loads can specifically be executed, by means of an application, prior to the start-up of the powertrain or during the operation of the powertrain, wherein physical variables are determined which are characteristic of the mechanical loads. Addition gives a sum of the multi-phase output voltage and the specifiable voltage. Specifically, the number of phases in the specifiable voltage corresponds to the number of phases in the determined multi-phase output voltage. The combined voltage characteristic constitutes the output for the multi-phase supply of the electric machine. Advantageously, a method is provided for the reduction of individual mechanical loads in a powertrain. The reduction of mechanical loads is simultaneously associated with a reduction of noise emissions from the powertrain.

In another configuration of the invention, a fundamental frequency of the multi-phase output voltage is significantly higher than a frequency of the specifiable voltage and, specifically, the difference between the fundamental frequency of the multi-phase output voltage and the frequency of the specifiable voltage rises as the number of pole pairs in the electric machine increases.

A method for reducing mechanical loads in a powertrain is provided, wherein the output for the supply of the electric machine is constituted by the sum of a multi-phase output voltage and a specifiable voltage. A fundamental frequency of the multi-phase output voltage is higher than a frequency of the specifiable voltage in this case. The fundamental frequency of the multi-phase output voltage thus corresponds to the electrical frequency of the electric machine, specifically to the electrical stator frequency of the electric machine. The magnitude of the fundamental frequency of the multi-phase output voltage corresponds to a customary operating frequency between the order of 0 Hz up to the order of 15 kHz. The frequency of the specifiable voltage to be added corresponds to a lower frequency than the fundamental frequency, and also lies within the range of approximately 0 Hz to 15 kHz. Specifically, the difference between the fundamental frequency of the multi-phase output voltage and the frequency of the specifiable voltage rises as the number of pole pairs in the electric machine increases. Specifically, the fundamental frequency of the multi-phase output voltage corresponds to between 2 and 6 times the frequency of the specifiable voltage. Specifically, the frequency of the specifiable voltage lies within a range of the mechanically-induced oscillations associated with the operation of the electric machine and the powertrain. Advantageously, parameters are provided for the adjustment of electrical voltages for the purposes of the implementation of the method.

In another configuration of the invention, the method comprises the following additional steps: determination of a speed of rotation of the powertrain, and specification of the frequency, amplitude or phase angle of the specifiable voltage in accordance with the speed of rotation thus determined.

A speed of rotation of the powertrain is determined and, in accordance with the speed of rotation thus determined, the frequency, amplitude or phase angle of the specifiable voltage are specified. As the speed of rotation of a shaft or a gear wheel within the powertrain increases, mechanical loads applied to individual bearings vary in a differential manner. By means of a corresponding adjustment or specification of the frequency, amplitude or phase angle of the specifiable voltage, variations in mechanical loads are counteracted. Advantageously, a further improved method for reducing mechanical loads in a powertrain is thus provided.

In another configuration of the invention, as a frequency for the frequency of the specifiable voltage, the speed of rotation of the rotor of the electric machine, the speed of rotation of a drive shaft in the powertrain, or the speed of rotation of a drive wheel in the powertrain is specified.

The speed of rotation of the rotor of the electric machine, the speed of rotation of a drive shaft in the powertrain, or the speed of rotation of a drive wheel in the powertrain is determined, and is specified as a frequency for the frequency of the specifiable voltage. Determination of the speed of rotation is specifically executed by means of a speed sensor, or by means of another sensor which delivers a characteristic variable for the corresponding speed of rotation. Advantageously, an improved method for reducing mechanical loads is thus provided.

In another configuration of the invention, the method comprises the following additional steps: determination of a structure-borne noise signal of the powertrain, and specification of the frequency, amplitude or phase angle of the specifiable voltage in accordance with the structure-borne noise signal thus determined.

On the grounds of varying mechanical loads in the powertrain, the associated structure-borne noise signal thereof also varies accordingly. Consequently, the frequency, amplitude or phase angle of the specifiable voltage is specified in accordance with a structure-borne noise signal thus determined. Advantageously, an improved method for reducing mechanical loads in a powertrain is thus provided.

In another configuration of the invention, an acceleration sensor or a microphone is provided on the powertrain for the determination of the structure-borne noise signal. This is specifically fitted to or onto the electric machine, to a gearbox, to a drive wheel mounting, to a drive shaft, to a drive shaft bearing, to a power electronics unit, to an inverter, to a rectifier or to a battery, specifically for the propulsion of the electric machine.

For the determination of the structure-borne noise signal, an acceleration sensor or a microphone is provided on the powertrain. Structure-borne noise is propagated over the entire powertrain, such that the sensing thereof can be executed by means of an acceleration sensor or microphone at virtually any desired location on the powertrain. Specifically, a sensor of this type can be fitted to or onto the electric machine, specifically to a flange-mounted gearbox of the powertrain, to a drive shaft, to a drive wheel mounting or to a drive shaft bearing. Further installation sites for a sensor of this type can include, for example, the power electronics unit, an inverter, a rectifier or a battery, which is specifically provided for the propulsion of the electric machine. Advantageously, options are thus provided for the determination of the structure-borne noise signal in a method for reducing mechanical loads.

In another configuration of the invention, the method comprises the following additional steps: determination of the resulting phase voltages or phase currents of the electric machine, and specification of the frequency, amplitude or phase angle of the specifiable voltage, in accordance with the phase voltages or phase currents thus determined.

Varying mechanical loads in a powertrain also result in erratic phase voltages or phase currents on the electric machine. Consequently, on the basis of the resulting phase voltages or phase currents thus determined, the frequency, amplitude or phase angle of the specifiable voltage is specified, in order to reduce mechanical loads. Advantageously, an improved method for reducing mechanical loads is thus provided.

In another configuration of the invention, for the determination of the resulting phase voltage or phase currents on the electric machine, a voltage or current sensor is provided. This is specifically fitted to the electric machine.

It is appropriate that, to the nearest extent possible, the resulting phase voltages or phase currents should be measured directly on the electric machine. To this end, a voltage or current sensor is provided which, specifically, is directly fitted to or into the electric machine. Advantageously, options for the determination of the resulting phase voltages or phase currents are thus provided.

The invention further relates to a computer program, which is designed to execute the method described.

The invention further relates to a machine-readable storage medium, on which the computer program described is saved.

The invention further relates to a device for reducing mechanical loads in a powertrain. An electric machine is provided as the drive assembly of the powertrain, and an inverter is provided for the output of a multi-phase output voltage for supplying the electric machine. The device is designed for the determination of the multi-phase output voltage for operating the electric machine, for the addition of a specifiable voltage to the output voltage thus determined, and for the output of the sum of the multi-phase output voltage and the specifiable voltage for the supply of the electric machine, as a desired variable, to an inverter, specifically for the supply of the electric machine.

A device is provided for reducing mechanical loads in a powertrain. An electric machine is provided as the drive assembly of the powertrain, which receives a multi-phase output voltage from an inverter by way of a power supply. The device determines the multi-phase output voltage for operating the electric machine, for example in accordance with a driver instruction. The device further adds a specifiable voltage to the output voltage thus determined. The sum of the multi-phase output voltage and the specifiable voltage is delivered as a desired variable output from the device to an inverter which, in accordance with this desired variable, delivers a multi-phase output voltage for the supply of the electric machine. Advantageously, a device for reducing mechanical loads in a powertrain is thus provided.

The invention further relates to a powertrain having an inverter, an electric machine and a device described above.

An electric powertrain is provided, comprising an inverter, an electric machine and a device described above. Advantageously, a powertrain is provided, having a device which reduces mechanical loads in a powertrain.

The invention further relates to a vehicle having a powertrain described above. Advantageously, a vehicle is thus provided, having a device for reducing mechanical loads in the powertrain.

It is understood that the characteristics, properties and advantages of the method according to the invention correspondingly relate to, or are applicable to, the device or the powertrain, and to the vehicle and vice versa.

Further characteristics and advantages of forms of embodiment of the invention proceed from the following description, with reference to the attached drawings.

### BRIEF DESCRIPTION OF THE DRAWINGS

The invention is described in greater detail hereinafter, with reference to a number of figures. In the figures:

FIG. 1 shows a schematically represented vehicle, having a powertrain and a device,

FIG. 2 shows a schematically represented voltage diagram,

FIG. 3 shows a schematically represented flow diagram of a method for reducing mechanical loads in a powertrain

### DETAILED DESCRIPTION

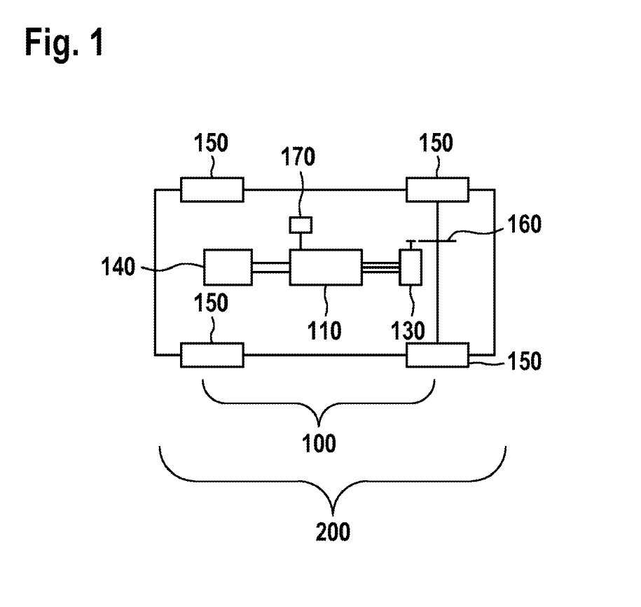

FIG. 1 shows a schematically represented vehicle having, for example, four wheels 150. The vehicle comprises a powertrain 100. The powertrain comprises an electric machine 130, which is connected via a gearbox 160 to a drive shaft and the drive wheels. An inverter 110 converts the electrical energy from a battery 140, specifically a high-voltage battery, into a multi-phase output voltage, with which the electric machine 130 is supplied. The powertrain 100 further comprises a device 170, which controls the inverter 110. Specifically, the device 170 is integrated in the inverter 110 as a functional unit. The device 170 for the reduction of mechanical loads in a powertrain is designed to determine a multi-phase output voltage UA for the operation of the electric machine 130, and to add a specifiable voltage VU to the multi-phase output voltage UA thus determined. The device 170 delivers the sum SU of the multi-phase output voltage UA and the specifiable voltage VU for the supply of the electric machine 130 as a desired variable on the inverter 110. The inverter 110 supplies the electric machine 130 with a voltage which corresponds to the sum SU of the multi-phase output voltage UA and the specifiable voltage VU.

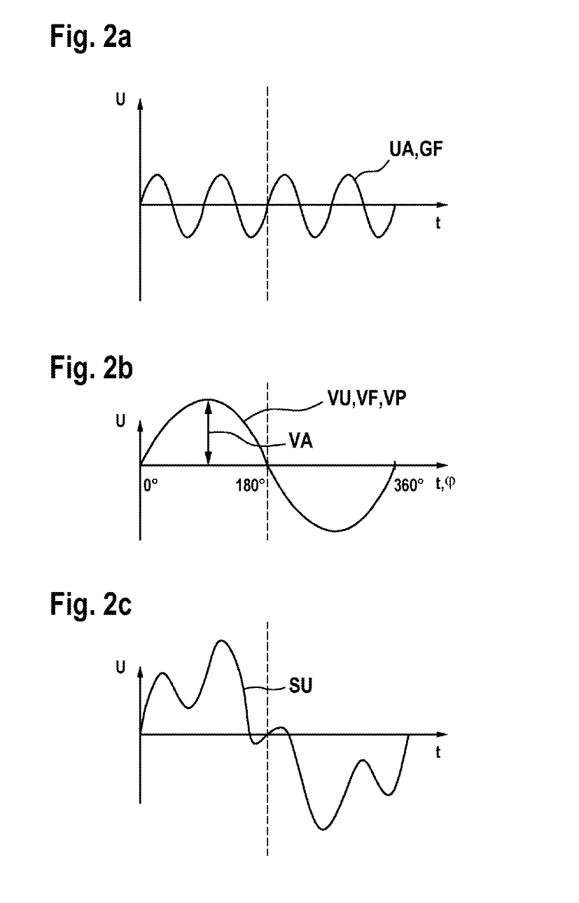

FIG. 2 shows three diagrams, each of which represents a voltage characteristic over time t. Diagram 2a shows an exemplary voltage characteristic of one phase of the multi-phase voltage UA, which is determined by means of the device 170 for the operation of the electric machine, specifically in accordance with a preferred torque. The output voltage UA in an alternating voltage with a relatively high fundamental frequency GF. FIG. 2b shows the voltage characteristic of a specifiable voltage VU, plotted against time t and the angle Phi. The voltage VU is an alternating voltage of frequency VF, phase angle VP and amplitude VA. These parameters for the specifiable voltage VU are specified by means of the device 170, and can specifically be adjusted, for example in accordance with a speed of rotation of the powertrain or a structure-borne noise signal, or with the determined phase voltages and phase currents. The parameters are applied or adjusted, such that the mechanical loads in the operation of the powertrain are reduced. For the operation of the electric machine 130, the specifiable voltage VU, specifically with the adjusted phase angle, is now added to the output voltage UA. The sum SU of the output voltage UA and the specifiable voltage VU gives the voltage characteristic represented in the diagram 2c. By means of the specification of this desired variable on the inverter 110 by the device 170, the electric machine 130 is energized with the voltage characteristic represented. As a result, a reduction of mechanical loads in the powertrain is achieved.

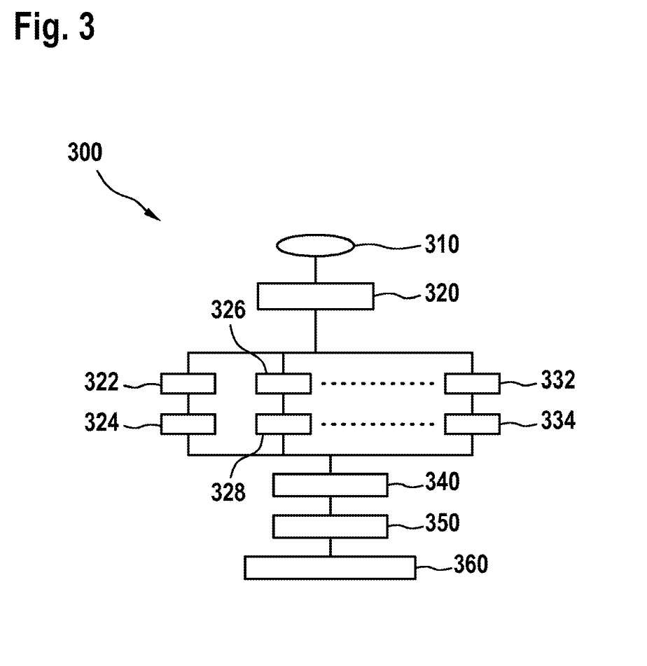

FIG. 3 shows a schematic representation of a flow diagram of the method 300 for reducing mechanical loads in a powertrain 100. The method commences with step 310. In step 320, the multi-phase output voltage for the operation of the electric machine 130 is determined, specifically in accordance with a preferred torque. In the subsequent exemplary steps 322, 326 and 332 represented, at least one parameter on the powertrain is detected, e.g. a speed of rotation of the powertrain, a structure-borne noise signal of the powertrain, or the resulting phase voltages or phase currents on the powertrain, for example by means of a sensor. In the respective subsequent steps 324, 328 or 334, in accordance with the respective parameter determined, the frequency VF, amplitude VA or phase angle VP of the specifiable voltage VU is determined. In the subsequent step 340, the output voltage UA is added to the specifiable voltage VU. This gives the sum SU. In step 350, the sum SU of the multi-phase output voltage UA and the specifiable voltage VU is delivered as a desired variable for the supply of the electric machine 130 on the inverter 110. The inverter 110 generates a voltage characteristic corresponding to the desired variable for the supply of the electric machine 130, which correspondingly drives the powertrain with reduced mechanical loads. The method ends at step 360.

1. A method (300) for reducing mechanical loads in a powertrain (100), wherein an electric machine (130) is provided as the drive assembly of the powertrain (100), and an inverter (110) is provided for the output of a multi-phase output voltage for supplying the electric machine (130), the method comprising:
determining (320) a multi-phase output voltage UA for operating the electric machine (130);
adding (340) a specifiable voltage (VU) and the specified multi-phase output voltage (UA);
outputting (340) the sum (SU) of the multi-phase output voltage (UA) and the specifiable voltage (VU) for the supply of the electric machine (130).

2. The method (300) as claimed in claim 1, wherein a fundamental frequency (GF) of the multi-phase output voltage (UA) is higher than a frequency (VF) of the specifiable voltage.

3. The method (300) as claimed in claim 1, further comprising:
determining a speed of rotation (322) of the powertrain (100), and specification (324) of a frequency (VF), amplitude (VA) or phase angle (VP) of the specifiable voltage (VU) in accordance with the determined speed of rotation.

4. The method (300) as claimed in claim 3, wherein, as a frequency for the frequency (VF) of the specifiable voltage, the speed of rotation of the rotor of the electric machine (130), the speed of rotation of a drive shaft in the powertrain (100), or the speed of rotation of a drive wheel (150) in the powertrain (100) is specified.

5. The method (300) as claimed in claim 1, further comprising:
determining a structure-borne noise signal (326) of the powertrain (100), and specification (328) of a frequency (VF), amplitude (VA) or phase angle (VP) of the specifiable voltage (VU) in accordance with the structure-borne noise signal thus determined.

6. The method (300) as claimed in claim 5, wherein, for the determination of the structure-borne noise signal (326), an acceleration sensor or a microphone is provided on the powertrain (100).

7. The method (300) as claimed in claim 1, further comprising:
determining resulting phase voltages or phase currents (332) of the electric machine (130), and specification (334) of the frequency (VF), amplitude (VA) or phase angle (VP) of the specifiable voltage (VU), in accordance with the phase voltages or phase currents thus determined.

8. method (300) as claimed in claim 7, wherein, for the determination of the resulting phase voltages or phase currents on the electric machine (130), a voltage or current sensor is provided.

9. A non-transitory machine-readable storage medium having a computer program, which configured to execute the method (300) as claimed in claim 1.

10. (canceled)

11. A device (170) for reducing mechanical loads in a powertrain (100), wherein an electric machine (130) is provided as the drive assembly of the powertrain (100), and an inverter (110) is provided for the output of a multi-phase output voltage (UA) for supplying the electric machine (130),
wherein the device (170) is configured to determine the multi-phase output voltage (UA) for operating the electric machine (130); addition of a specifiable voltage (VU) to the determined output voltage (UA); and output of the sum (SU) of the multi-phase output voltage (UA) and the specifiable voltage (VU) for the supply of the electric machine (130), as a desired variable on the inverter (110).

12. A powertrain (100) having an inverter (110), an electric machine (130) and a device (170) as claimed in claim 11.

13. A vehicle (200) having a powertrain (100) as claimed in claim 12.

14. The method (300) as claimed in claim 1, wherein a fundamental frequency (GF) of the multi-phase output voltage (UA) is higher than a frequency (VF) of the specifiable voltage and, the difference between the fundamental frequency (GF) of the multi-phase output voltage (UA) and the frequency (VF) of the specifiable voltage rises as the number of pole pairs in the electric machine (130) increases.

15. The method (300) as claimed in claim 6, wherein the acceleration sensor or microphone is provided on the electric machine (130), on a gearbox (160) of the powertrain (100), on a drive wheel mounting, on a drive shaft, on a drive shaft bearing, on a power electronics unit, on an inverter (110), on a rectifier or on a battery (140) for the propulsion of the electric machine (130).

16. method (300) as claimed in claim 8, wherein the voltage or current sensor is provided on the electric machine (130).
